(19) United States
(12) Patent Application Publication
(10) Pub. No.: US 2018/0024245 A1
(43) Pub. Date: Jan. 25, 2018

(54) DETERMINING COORDINATES OF A POINT IN THREE-DIMENSIONAL SPACE

(71) Applicant: Prologue Systems, LLC, Richmond, VA (US)

(72) Inventor: F. SCOTT REED, JR., RICHMOND, VA (US)

(21) Appl. No.: 15/650,708

(22) Filed: Jul. 14, 2017

Related U.S. Application Data
(60) Provisional application No. 62/366,247, filed on Jul. 25, 2016.

(51) Int. Cl. G01S 17/42; G01S 7/481; G01S 7/497; G01S 17/89

(52) U.S. Cl. CPC G01S 17/42; G01S 17/89; G01S 7/4817; G01S 7/497

(57) ABSTRACT

A method of determining 3D coordinates of a reference point comprises positioning a targeting device comprising an elongated rigid rod having an end point and first and second scanning targets affixed to the rod, the targeting device positioned such that the end point contacts the reference point; scanning the targeting device; determining, using the scan data, (i) 3D coordinates of the center point of the first target and (ii) 3D coordinates of the center point of the second target; and calculating 3D coordinates of the end point based on (i) the 3D coordinates of the center point of the first target, (ii) the 3D coordinates of the center point of the second target, (iii) a distance between the center point of the first target and the end point, and (iv) a distance between the center point of the second target and the end point.

### CROSS-REFERENCE TO RELATED APPLICATIONS

This application is a non-provisional of and claims priority to U.S. Provisional Patent Application Ser. No. 62/366,247, filed Jul. 25, 2016, the contents of which are incorporated herein by reference in its entirety.

### FIELD OF THE INVENTION

The present invention relates to imaging using a Lidar scanner or a similar device.

### BACKGROUND OF THE DISCLOSURE

Lidar (light detection and ranging) is a surveying technology that measures distance by illuminating a target with a laser light. Lidar is popularly used as a technology to make high-resolution three-dimensional (3D) maps, for many different purposes.

When performing Lidar imaging, it is often desirable to determine the coordinates in 3D space of a specific point (which may be termed a reference point). In construction, such a reference point is often on the floor or ground. Conventionally, the coordinates of a reference point on the floor or ground are determined using a spherical target mounted on a tripod or pole. The spherical target must be positioned exactly above the reference point (this positioning is typically achieved by using a bubble level or the like). The precise height of the center of the spherical target above the reference point must be known. The spherical target is then imaged using Lidar to determine the 3D coordinates of the center of the spherical target (conventional Lidar is readily able to determine the 3D coordinates of the center of a scanned spherical target). By knowing the 3D coordinates of the center of the spherical target and the height of the center of the spherical target above the reference point, it is then easy to determine the 3D coordinates of the reference point.

In addition to the method described in the preceding paragraph, there are other known methods of determining the coordinates in 3D space of a specific point.

The conventional method of using a spherical target mounted on a tripod or pole has many shortcomings (as do the other known methods). When using the conventional method it is difficult or impossible to determine the coordinates of a reference point that is not on the floor or ground. Even if the reference point is on the floor or ground, if the reference point is too close to a wall or other obstruction it may be difficult or impossible to determine the coordinates using the conventional method. When using the conventional method, it is difficult to ensure that the spherical target is positioned exactly above the reference point.

### BRIEF SUMMARY OF THE DISCLOSURE

Systems, devices, and methods for determining coordinates (x, y, z) of a point in three-dimensional space using a Lidar imaging device (or a similar device) are disclosed herein. In one embodiment of the invention, a method of determining 3D coordinates of a reference point comprises positioning a targeting device, the targeting device comprising (i) an elongated rigid rod having an end point, (ii) a first scanning target affixed to the rod such that the rod is aligned with a center point of the first scanning target, and (iii) a second scanning target affixed to the rod such that the rod is aligned with a center point of the second scanning target, the targeting device positioned such that the end point contacts the reference point; scanning the targeting device (such as by using a Lidar scanner or a similar device); determining, using scan data from the scanning of the targeting device, (i) 3D coordinates of the center point of the first scanning target and (ii) 3D coordinates of the center point of the second scanning target; and calculating 3D coordinates of the end point based on (i) the 3D coordinates of the center point of the first scanning target, (ii) the 3D coordinates of the center point of the second scanning target, (iii) a distance between the center point of the first scanning target and the end point, and (iv) a distance between the center point of the second scanning target and the end point. The first scanning target may comprise a first sphere and the second scanning target may comprise a second sphere.

The method may further comprise calculating a distance between the center point of the first scanning target and the end point based on (i) a distance between the center point of the second scanning target and the end point and (ii) a distance between the center point of the first scanning target and the center point of the second scanning target.

The method may further comprise calculating a distance between the center point of the second scanning target and the end point based on (i) a distance between the center point of the first scanning target and the end point and (ii) a distance between the center point of the first scanning target and the center point of the second scanning target.

The method may further comprise positioning the targeting device such that the end point contacts a calibration point of a calibration target; scanning the targeting device and the calibration target; determining, using scan data from the scanning of the targeting device and the calibration target, (i) 3D coordinates of the center point of the first scanning target, (ii) 3D coordinates of the center point of the second scanning target, and (iii) 3D coordinates of the calibration point; and calculating at least one of (1) the distance between the center point of the first scanning target and the end point and (2) the distance between the center point of the second scanning target and the end point based on (a) the 3D coordinates of the center point of the first scanning target from the scanning of the targeting device and the calibration target, (b) the 3D coordinates of the center point of the second scanning target from the scanning of the targeting device and the calibration target, and (c) the 3D coordinates of the calibration point from the scanning of the targeting device and the calibration target.

In alternative embodiments of the invention, a method of determining 3D coordinates of a reference point comprises scanning a targeting device (such as by using a Lidar scanner or a similar device), the targeting device comprising (i) an elongated rigid rod having an end point, (ii) a first scanning target affixed to the rod such that the rod is aligned with a center point of the first scanning target, and (iii) a second scanning target affixed to the rod such that the rod is aligned with a center point of the second scanning target, the targeting device positioned such that the end point contacts the reference point; determining, using scan data from the scanning of the targeting device, (i) 3D coordinates of the center point of the first scanning target and (ii) 3D coordinates of the center point of the second scanning target; and calculating 3D coordinates of the end point based on (i) the 3D coordinates of the center point of the first scanning target, (ii) the 3D coordinates of the center point of the second scanning target, (iii) a distance between the center point of the first scanning target and the end point, and (iv) a distance between the center point of the second scanning target and the end point. The first scanning target may comprise a first sphere and the second scanning target may comprise a second sphere.

The method may further comprise calculating a distance between the center point of the first scanning target and the end point based on (i) a distance between the center point of the second scanning target and the end point and (ii) a distance between the center point of the first scanning target and the center point of the second scanning target.

The method may further comprise calculating a distance between the center point of the second scanning target and the end point based on (i) a distance between the center point of the first scanning target and the end point and (ii) a distance between the center point of the first scanning target and the center point of the second scanning target.

The method may further comprise positioning the targeting device such that the end point contacts a calibration point of a calibration target; scanning the targeting device and the calibration target; determining, using scan data from the scanning of the targeting device and the calibration target, (i) 3D coordinates of the center point of the first scanning target, (ii) 3D coordinates of the center point of the second scanning target, and (iii) 3D coordinates of the calibration point; and calculating at least one of (1) the distance between the center point of the first scanning target and the end point and (2) the distance between the center point of the second scanning target and the end point based on (a) the 3D coordinates of the center point of the first scanning target from the scanning of the targeting device and the calibration target, (b) the 3D coordinates of the center point of the second scanning target from the scanning of the targeting device and the calibration target, and (c) the 3D coordinates of the calibration point from the scanning of the targeting device and the calibration target.

In alternative embodiments of the invention, a method of determining 3D coordinates of a reference point comprises receiving scan data from a scan of a targeting device (such as by a Lidar scanner or a similar device), the targeting device comprising (i) an elongated rigid rod having an end point, (ii) a first scanning target affixed to the rod such that the rod is aligned with a center point of the first scanning target, and (iii) a second scanning target affixed to the rod such that the rod is aligned with a center point of the second scanning target, the targeting device positioned such that the end point contacts the reference point; determining, using the received scan data from the scanning of the targeting device, (i) 3D coordinates of the center point of the first scanning target and (ii) 3D coordinates of the center point of the second scanning target; and calculating 3D coordinates of the end point based on (i) the 3D coordinates of the center point of the first scanning target, (ii) the 3D coordinates of the center point of the second scanning target, (iii) a distance between the center point of the first scanning target and the end point, and (iv) a distance between the center point of the second scanning target and the end point. The first scanning target may comprise a first sphere and the second scanning target may comprise a second sphere.

The method may further comprise calculating a distance between the center point of the first scanning target and the end point based on (i) a distance between the center point of the second scanning target and the end point and (ii) a distance between the center point of the first scanning target and the center point of the second scanning target.

The method may further comprise calculating a distance between the center point of the second scanning target and the end point based on (i) a distance between the center point of the first scanning target and the end point and (ii) a distance between the center point of the first scanning target and the center point of the second scanning target.

The method may further comprise receiving scan data from a scan of a targeting device and a calibration target, the targeting device positioned such that the end point contacts a calibration point of the calibration target; determining, using the received scan data from the scanning of the targeting device and the calibration target, (i) 3D coordinates of the center point of the first scanning target, (ii) 3D coordinates of the center point of the second scanning target, and (iii) 3D coordinates of the calibration point; and calculating at least one of (1) the distance between the center point of the first scanning target and the end point and (2) the distance between the center point of the second scanning target and the end point based on (a) the 3D coordinates of the center point of the first scanning target from the scanning of the targeting device and the calibration target, (b) the 3D coordinates of the center point of the second scanning target from the scanning of the targeting device and the calibration target, and (c) the 3D coordinates of the calibration point from the scanning of the targeting device and the calibration target.

In addition to the methods of determining 3D coordinates of a reference point, as described above, other aspects of the present invention are directed to corresponding systems and devices for determining 3D coordinates of a reference point.

### BRIEF DESCRIPTION OF THE SEVERAL VIEWS OF THE DRAWINGS

The foregoing summary, as well as the following detailed description of the disclosure, will be better understood when read in conjunction with the appended drawings. For the purpose of illustrating the disclosure, there are shown in the drawings embodiments which are presently preferred. It should be understood, however, that the disclosure is not limited to the precise arrangements and instrumentalities shown. In the drawings:

FIG. 1 is a side view of a Lidar targeting device, in accordance with embodiments of the present invention.

FIG. 2 is a side view of a Lidar targeting device, in accordance with alternative embodiments of the present invention.

FIG. 3 is a side view of a Lidar targeting device, in accordance with alternative embodiments of the present invention.

FIG. 4 is a side view of a Lidar targeting device, in accordance with alternative embodiments of the present invention.

FIG. 5 illustrates a method of determining the coordinates of a reference point using the Lidar targeting device of FIG. 1.

### DETAILED DESCRIPTION OF THE DISCLOSURE

Certain terminology is used in the following description for convenience only and is not limiting. The words “lower,” “bottom,” “upper,” and “top” designate directions in the drawings to which reference is made. The words “inwardly,” “outwardly,” “upwardly” and “downwardly” refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

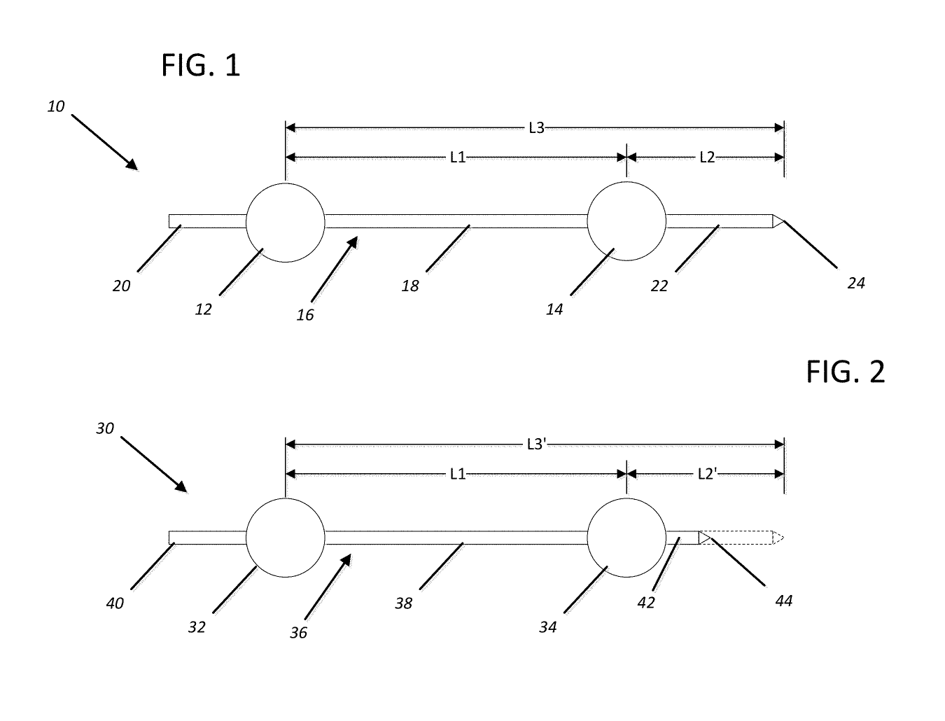

Embodiments of the invention are directed to novel systems, devices, and methods for determining coordinates (x, y, z) of a point in three-dimensional space using a Lidar imaging device or a similar imaging/scanning device (such as a total station device). Referring now to FIG. 1, a Lidar targeting device 10 is illustrated in accordance with embodiments of the invention. Targeting device 10 comprises a first sphere 12 and a second sphere 14 mounted to an elongated rigid rod 16. The spheres 12, 14 may be constructed of any suitable material, including metal, plastic, etc. (Lidar targeting spheres are known and readily available). The rod 16 may be constructed of any suitable rigid material, such as metal, plastic etc. The rod 16 typically extends through precisely centered holes in the spheres. The rod 16 comprises a middle portion 18 between the two spheres, a designating portion 22 having a narrowed or pointed end 24, and an optional free portion 20 opposite the designating portion 22. Importantly, (i) the distance L1 between the centers of the spheres is a fixed, known (or readily determined) distance and (ii) the distance L2 between the center of the second sphere 14 and the end point 24 and/or the distance L3 between the center of the first sphere 12 and the end point 24 are fixed, known (or readily determined) distances (except as described below). (If L1 and L2 are known, then L3 is readily determined. If L1 and L3 are known, then L2 is readily determined. If L2 and L3 are known, then L1 is readily determined. Additionally, L1, L2, and/or L3 may be determined by a calibration process, as described below.) The spheres may be identically sized, or may be different sized to enable a user to more readily determine which end of the targeting device is the designating portion.

To determine the coordinates of a reference point, the targeting device 10 is positioned such that the end point 24 is touching the reference point. Advantageously, the position and orientation of the targeting device 10 does not matter, as long as the end point 24 is touching the reference point. The targeting device 10 should be steadily maintained in the position during the scanning operation. The targeting device 10 may be held in the position in which the end point 24 is touching the reference point using any suitable securing device, including but not limited to tripods, clamps, suction cups, etc. Because of the flexibility of positioning the targeting device 10, it is possible to determine the coordinates of a reference point in many circumstances in which such determinations were not possible using conventional methods.

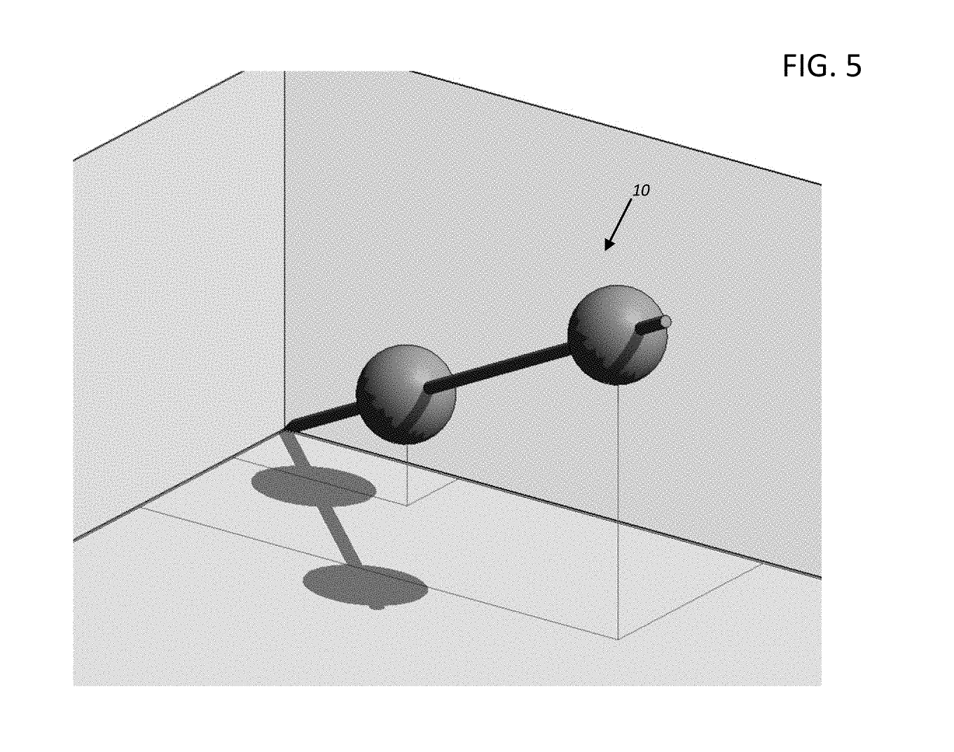

Once the targeting device 10 is in the position in which the end point 24 is touching the reference point, the targeting device 10 is scanned using a conventional Lidar scanner (not illustrated). FIG. 5 illustrates one example of how the targeting device 10 may be positioned (the securing device is omitted for clarity).

By scanning the targeting device 10, the Lidar scanner is able to provide precise coordinates of the center points of the spheres 12, 14. By determining the precise coordinates of the center points of the spheres 12, 14, the vector of the rod 16 can be determined. The precise coordinates of the center points of the spheres 12, 14 and the vector of the rod 16 can be combined with the known distance between the end point 24 and the first sphere 12 and/or the second sphere 14 to determine the coordinates of the end point 24. The coordinates of the end point 24 are the same as the coordinates of the reference point, as the end point 24 is touching the reference point. One example of the calculations used to determine the coordinates of the end point 24 is illustrated in the following paragraphs.

The coordinates of the center of the second sphere 14 may be represented by x′, y′ and z′. The coordinates of the center of the first sphere 12 may be represented by x″, y″ and z″. The straight line distance from the end point 24 to the second sphere 14 may be represented by Δ′. The straight line distance from the end point 24 to the first sphere 12 may be represented by Δ″. The coordinates to be determined of the end point 24/reference point may be represented by x, y and z. Given these variables described above:

$$\frac{( {Δ}^{′} )}{( {x}^{′} - x )} = \frac{( {Δ}^{″} )}{( {x}^{″} - x )} = \frac{( {Δ}^{″} - {Δ}^{′} )}{( {x}^{″} - {x}^{′} )} .$$

Arranging based on known values in the configuration:

$$\frac{( {Δ}^{′} ) ( {x}^{″} - x )}{1} = \frac{( {Δ}^{″} ) ( {x}^{′} - x )}{1} .$$

Solving for x:

(Δ′)(x″−x)=(Δ″)(x′−x).

Isolating x:

$${x}^{″} {Δ}^{′} - x {Δ}^{′} = {Δ}^{″} {x}^{′} - {Δ}^{″} x ;$$

$${Δ}^{″} x - x {Δ}^{′} = {Δ}^{″} {x}^{′} - {x}^{″} {Δ}^{′} ;$$

$$x ( {Δ}^{″} - {Δ}^{′} ) = {Δ}^{″} {x}^{′} - {x}^{″} {Δ}^{′} ; and$$

$$x = \frac{{Δ}^{″} {x}^{′} - {x}^{″} {Δ}^{′}}{( {Δ}^{″} - {Δ}^{′} )} .$$

As for x, so is y and z. Therefore:

$$x = \frac{{Δ}^{″} {x}^{′} - {x}^{″} {Δ}^{′}}{( {Δ}^{″} - {Δ}^{′} )} ; y = \frac{{Δ}^{″} {y}^{′} - {y}^{″} {Δ}^{′}}{( {Δ}^{″} - {Δ}^{′} )} ; and z = \frac{{Δ}^{″} {z}^{′} - {z}^{″} {Δ}^{′}}{( {Δ}^{″} - {Δ}^{′} )} .$$

By extension, it is not necessary that the distance Δ′ or Δ″ be fixed, so long as the distance between the spheres (Δ″−Δ′) is known. Referring now to FIG. 2, a Lidar targeting device is illustrated in accordance with alternative embodiments of the present invention. Lidar targeting device 30 of FIG. 2 comprises a first sphere 32 and a second sphere 34 mounted to an elongated rigid rod 36. The rod 36 comprises a middle portion 38 between the two spheres, a designating portion 42 having a narrowed or pointed end 44, and an optional free portion 40 opposite the designating portion 42. Notably, the designating portion 42 is adjustable/extendible, as illustrated by the dashed lines in FIG. 2. The designating portion 42 may be infinitely adjustable between two positions (shortest and longest), or may be adjustable along a finite number of positions/stops between the shortest and longest positions. The adjustability of the designating portion 42 may make it easier to place the end point 44 on the reference point. Because the designating portion 42 is adjustable, the distance L2′ between the center of the second sphere 34 and the end point 44 and the distance L3′ between the center of the first sphere 32 and the end point 44 are variable. It is still, however, necessary to know either distance L2′ or L3′ to determine the coordinates of the end point 44. As such, distance L2′ or L3′ must be determined after the designating portion 42 is adjusted. Distance L2′ and/or L3′ may be determined using any suitable mechanism or method, such as position markings or a mechanical or electronic gauge. Once distance L2′ and/or L3′ are determined, the determination of the coordinates of the end point 44 may be accomplished as described above.

While the targeting devices are described herein as having spheres as scanning targets, targeting devices of embodiments of the invention may comprise any other suitable type of scanning targets. For example, targeting devices of embodiments of the invention may comprise checkerboard Lidar targets or total station prism targets. Whichever type of scanning targets are used, the center point of each scanning target must be aligned with the elongated rigid rod.

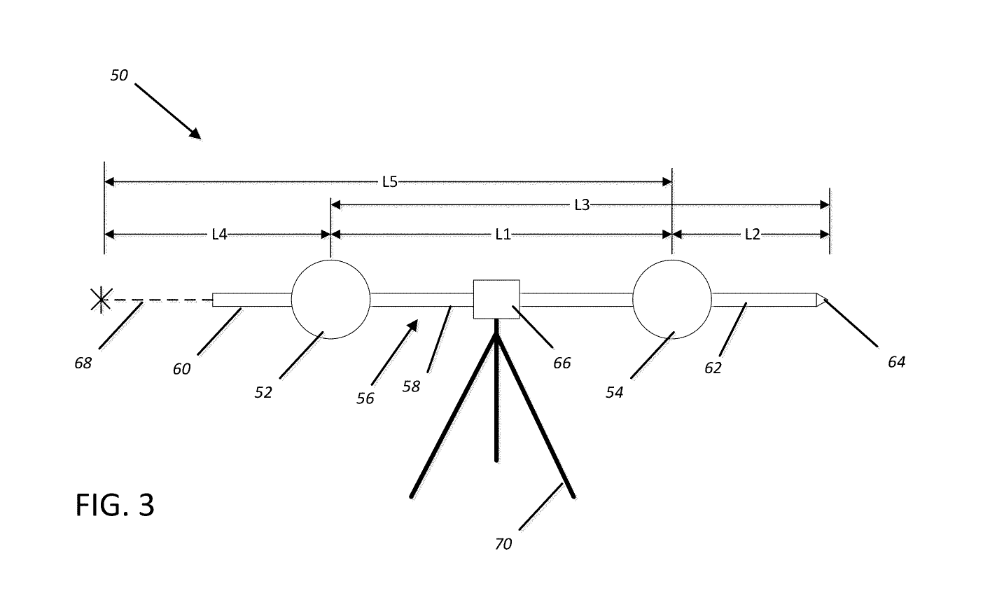

Referring now to FIG. 3, a Lidar targeting device is illustrated in accordance with alternative embodiments of the present invention. Lidar targeting device 50 of FIG. 3 comprises a first sphere 52 and a second sphere 54 mounted to an elongated rigid rod 56. The rod 56 comprises a middle portion 58 between the two spheres, a designating portion 62 having a narrowed or pointed end 64. Notably, targeting device 50 comprises a laser range finder (which may be housed in control box 66) which selectively causes a laser beam 68 to be emitted from laser end 60. The laser beam 68 is aimed at the reference point, and the targeting device 50 is secured in such a position that the laser beam 68 hits the reference point. The laser range finder enables determination of the distance L4 from the laser beam contact point (which is the reference point) to the first sphere 52 and/or the distance L5 from the laser beam contact point to the second sphere 54 without the targeting device 50 having to physically contact the reference point, thereby allowing for an infinite number of positioning arrangements of the targeting device. Depending on the location of the components of the laser range finder within the targeting device 50, an offset value may need to be used to convert the distance determined by the laser range finder to distance L4 or L5 (as described below). (While FIG. 3 illustrates the laser range finder being housed in a control box 66 that is positioned between the two spheres, the laser range finder (and housing, if any) may be positioned at any suitable location on the rod 56.) (Alternatively to a laser range finder, any other suitable non-contact mechanism for determining distance may be used.)

The mathematics of such an arrangement can be described as follows:

$$\frac{( {Δ}^{′} )}{( {x}^{′} - x )} = \frac{( {Δ}^{″} )}{( {x}^{″} - x )} = \frac{( {Δ}^{″} - {Δ}^{′} )}{( {x}^{″} - {x}^{′} )} ;$$

where:

Δ′ is the straight line distance between the laser projection and the closest sphere center, further described as Δ′=Δ_{L}−Δ_{Lo/s+};

where:

Δ_{L} is the distance from the laser to the reference point;

Δ_{Lo/s+} is the offset from the laser to the lower or adjacent sphere; and

Δ″ is the straight line distance between the laser projection and the farthest sphere center, further described as Δ″=Δ_{L}+Δ_{Lo/s-};

where:

Δ_{L} is the distance from the laser to the reference point;

Δ_{Lo/s-} is the offset from the laser to the upper or farthest sphere;

x′ is the x coordinate of the closest/lowest sphere center;

x″ is the x coordinate of the farthest/upper sphere center; and

x is the x coordinate of the unknown reference point.

By substitution, and extending the relationship of x to the y and z planes, the following relationships are derived:

$$x = \frac{( {Δ}_{L} + {Δ}_{Lo / s +} ) {x}^{′} - {x}^{″} ( {Δ}_{L} - {Δ}_{Lo / s -} )}{( ( {Δ}_{L} + {Δ}_{Lo / s +} ) - ( {Δ}_{L} - {Δ}_{Lo / s -} ) )} ;$$

$$y = \frac{( {Δ}_{L} + {Δ}_{Lo / s +} ) {y}^{′} - {y}^{″} ( {Δ}_{L} - {Δ}_{Lo / s -} )}{( ( {Δ}_{L} + {Δ}_{Lo / s +} ) - ( {Δ}_{L} - {Δ}_{Lo / s -} ) )} ; and$$

$$z = \frac{( {Δ}_{L} + {Δ}_{Lo / s +} ) {z}^{′} - {z}^{″} ( {Δ}_{L} - {Δ}_{Lo / s -} )}{( ( {Δ}_{L} + {Δ}_{Lo / s +} ) - ( {Δ}_{L} - {Δ}_{Lo / s -} ) )} .$$

The targeting device 50 of FIG. 3 includes both a fixed, mechanical designating portion 62 and the laser range finder, such that the targeting device 50 may be used in a “contact” mode (in which the targeting device 50 must physically contact the reference point) or a “non-contact” mode (in which the targeting device 50 need not physically contact the reference point). In alternative embodiments of the invention (not illustrated), a targeting device may include only a laser range finder for operating in a non-contact mode (and not a mechanical designating portion). In other alternative embodiments of the invention (not illustrated), a targeting device may include a fixed mechanical designating portion (as in the embodiment of FIG. 1) and an adjustable mechanical designating portion (as in the embodiment of FIG. 2). In other alternative embodiments of the invention (not illustrated), a targeting device may include a laser range finder and an adjustable mechanical designating portion (as in the embodiment of FIG. 2). In other alternative embodiments of the invention (not illustrated), a targeting device may include a selectively attachable and removable mechanical designating portion and a selectively attachable and removable laser range finder (which may both, for example, have threaded attachment mechanisms (or any other suitable attachment mechanism) to be attached to a corresponding threaded attachment mechanism (or any other suitable corresponding attachment mechanism) on a rod).

FIG. 3 illustrates the targeting device 50 supported by a tripod 70. Although not illustrated, such a tripod may be used with any of the illustrated embodiments.

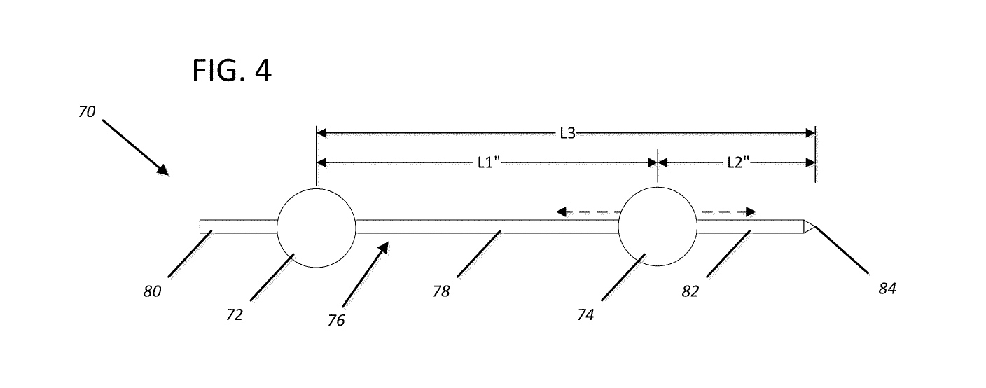

Referring now to FIG. 4, a Lidar targeting device is illustrated in accordance with alternative embodiments of the present invention. Lidar targeting device 70 of FIG. 4 comprises a first sphere 72 and a second sphere 74 mounted to an elongated rigid rod 76. The rod 76 comprises a middle portion 78 between the two spheres, a designating portion 82 having a narrowed or pointed end 84, and an optional free portion 80 opposite the designating portion 82. Notably, the second sphere 74 is adjustable, as illustrated by the dashed line double arrow in FIG. 4. The second sphere 74 may be infinitely adjustable between the first sphere 72 and the end point 84 (or some smaller portion of the rod 76 between the first sphere 72 and the end point 84), or may be adjustable along a finite number of positions/stops between the first sphere 72 and the pointed end 84 (or some smaller portion of the rod 76 between the first sphere 72 and the end point 84). The adjustability of the second sphere 74 may make it easier to position the targeting device 70 as needed to be able to place the end point 84 on the reference point. Once the second sphere 74 is positioned as desired, the second sphere 74 may be locked or otherwise fixed in the desired position using any suitable mechanism, such as a set screw, clamp, etc.

Because the position of the second sphere 74 is adjustable, the distance L1″ between the first sphere 72 and the second sphere 74 and the distance L2″ between the center of the second sphere 74 and the end point 84 are variable. It is still, however, necessary to know either distance L1″ or L2″ to determine the coordinates of the end point 84. As such, distance L1″ or L2″ must be determined after the second sphere 74 is adjusted (L3 is known or readily determined). Distance L1″ and/or L2″ may be determined using any suitable mechanism or method, such as position markings or a mechanical or electronic gauge. Once distance L1″ and/or L2″ are determined, the determination of the coordinates of the end point 84 may be accomplished as described above.

The second sphere 84 may be selectively slid on or off the rod 76. In this regard, the second sphere may be added to an existing elongated rod that has only a single sphere (such single sphere rods are conventionally known).

While FIG. 4 illustrates the second sphere as being adjustable, the first sphere may additionally or alternatively be adjustable and/or removable/replaceable.

As discussed above, it is necessary to know any two of L1, L2 and L3 to determine the location of the end point and therefore the reference point designated by the end point (knowing any two of L1, L2 and L3 enables determination of the third). If at least two of L1, L2 and L3 are not known (such as, for example, because the position of the second sphere has been adjusted), or if it is desirable to confirm the values of L1, L2 and L3, a calibration process may be performed. To determine/confirm L1, L2 and L3, the targeting device is positioned such that the end point is touching the calibration point of a conventional Lidar target, such as a checkerboard target. The targeting device and Lidar target are then scanned using a conventional Lidar scanner. The Lidar scanner is able to determine the 3D coordinates of the center of the two spheres of the targeting device and of the calibration point of the conventional Lidar target (which is the same as the 3D coordinates of the end point of the targeting device). Knowing the coordinates of the center of the first and second sphere and of the end point, the values for L1, L2 and L3 may be readily determined or confirmed. After L1, L2 and L3 are determined or confirmed, the targeting device may be repositioned such that the end point is designating the reference point for which the 3D coordinates are desired to be determined, and the targeting device is scanned again as described above.

The system, devices and methods of embodiments of the invention may be used in many different industries and applications. For example, the system, devices and methods of embodiments of the invention have many uses in the construction industry, such as identifying precise location of offset nail heads, locating top of monuments, determining finished floor elevation (FFE) offsets or gridlines snapped to floor without taping checkerboard targets, locating benchmarks or rebar establishing elevation control, and identifying location of small objects difficult to scan such as bolt heads, studs, anchors, sprinkler heads, mating keyways, shaft centerpoints, tiedowns, etc. The devices and methods of embodiments of the invention are even able to identify points that are not visible in the scan, such as bolt holes under a table top, studs on backside of columns, offsets hidden under batterboard, etc. The system, devices and methods of embodiments of the invention are able to quickly identify two such locations in a single scan by relocating the device during scan. Since orientation of the device does not affect calculation, setup is quick and temporary.

The present invention may be a system, a device, a method, and/or a computer program product at any possible technical detail level of integration. For example, a system of embodiments of the invention may comprise any of the herein described targeting devices and a Lidar scanner. Alternatively, a system of embodiments of the invention may comprise any of the herein described targeting devices, a Lidar scanner, and a computer program product for determining the coordinates of a point in three-dimensional space based on a scan of the targeting device using a Lidar imaging device. Yet further alternatively, a system of embodiments of the invention may comprise any of the herein described targeting devices and a computer program product for determining the coordinates of a point in three-dimensional space based on a scan of the targeting device using a Lidar imaging device. The computer program product may include a computer readable storage medium (or media) having computer readable program instructions thereon for causing a processor to carry out aspects of the present invention. A device of embodiments of the invention may comprise any of the herein described targeting devices.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention may be described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams (if any) in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A method of determining 3D coordinates of a reference point, the method comprising:
positioning a targeting device, the targeting device comprising (i) an elongated rigid rod having an end point, (ii) a first scanning target affixed to the rod such that the rod is aligned with a center point of the first scanning target, and (iii) a second scanning target affixed to the rod such that the rod is aligned with a center point of the second scanning target, the targeting device positioned such that the end point contacts the reference point;
scanning the targeting device;
determining, using scan data from the scanning of the targeting device, (i) 3D coordinates of the center point of the first scanning target and (ii) 3D coordinates of the center point of the second scanning target; and
calculating 3D coordinates of the end point based on (i) the 3D coordinates of the center point of the first scanning target, (ii) the 3D coordinates of the center point of the second scanning target, (iii) a distance between the center point of the first scanning target and the end point, and (iv) a distance between the center point of the second scanning target and the end point.

2. The method of claim 1, further comprising:
calculating a distance between the center point of the first scanning target and the end point based on (i) a distance between the center point of the second scanning target and the end point and (ii) a distance between the center point of the first scanning target and the center point of the second scanning target.

3. The method of claim 1, further comprising calculating a distance between the center point of the second scanning target and the end point based on (i) a distance between the center point of the first scanning target and the end point and (ii) a distance between the center point of the first scanning target and the center point of the second scanning target.

4. The method of claim 1, further comprising:
positioning the targeting device such that the end point contacts a calibration point of a calibration target;
scanning the targeting device and the calibration target;
determining, using scan data from the scanning of the targeting device and the calibration target, (i) 3D coordinates of the center point of the first scanning target, (ii) 3D coordinates of the center point of the second scanning target, and (iii) 3D coordinates of the calibration point; and
calculating at least one of (1) the distance between the center point of the first scanning target and the end point and (2) the distance between the center point of the second scanning target and the end point based on (a) the 3D coordinates of the center point of the first scanning target from the scanning of the targeting device and the calibration target, (b) the 3D coordinates of the center point of the second scanning target from the scanning of the targeting device and the calibration target, and (c) the 3D coordinates of the calibration point from the scanning of the targeting device and the calibration target.

5. The method of claim 1, wherein the first scanning target comprises a first sphere and the second scanning target comprises a second sphere.

6. A method of determining 3D coordinates of a reference point, the method comprising:
scanning a targeting device, the targeting device comprising (i) an elongated rigid rod having an end point, (ii) a first scanning target affixed to the rod such that the rod is aligned with a center point of the first scanning target, and (iii) a second scanning target affixed to the rod such that the rod is aligned with a center point of the second scanning target, the targeting device positioned such that the end point contacts the reference point;
determining, using scan data from the scanning of the targeting device, (i) 3D coordinates of the center point of the first scanning target and (ii) 3D coordinates of the center point of the second scanning target; and
calculating 3D coordinates of the end point based on (i) the 3D coordinates of the center point of the first scanning target, (ii) the 3D coordinates of the center point of the second scanning target, (iii) a distance between the center point of the first scanning target and the end point, and (iv) a distance between the center point of the second scanning target and the end point.

7. The method of claim 6, further comprising:
calculating a distance between the center point of the first scanning target and the end point based on (i) a distance between the center point of the second scanning target and the end point and (ii) a distance between the center point of the first scanning target and the center point of the second scanning target.

8. The method of claim 6, further comprising calculating a distance between the center point of the second scanning target and the end point based on (i) a distance between the center point of the first scanning target and the end point and (ii) a distance between the center point of the first scanning target and the center point of the second scanning target.

9. The method of claim 6, further comprising:
positioning the targeting device such that the end point contacts a calibration point of a calibration target;
scanning the targeting device and the calibration target;
determining, using scan data from the scanning of the targeting device and the calibration target, (i) 3D coordinates of the center point of the first scanning target, (ii) 3D coordinates of the center point of the second scanning target, and (iii) 3D coordinates of the calibration point; and
calculating at least one of (1) the distance between the center point of the first scanning target and the end point and (2) the distance between the center point of the second scanning target and the end point based on (a) the 3D coordinates of the center point of the first scanning target from the scanning of the targeting device and the calibration target, (b) the 3D coordinates of the center point of the second scanning target from the scanning of the targeting device and the calibration target, and (c) the 3D coordinates of the calibration point from the scanning of the targeting device and the calibration target.

10. The method of claim 6, wherein the first scanning target comprises a first sphere and the second scanning target comprises a second sphere.

11. A method of determining 3D coordinates of a reference point, the method comprising:
receiving scan data from a scan of a targeting device, the targeting device comprising (i) an elongated rigid rod having an end point, (ii) a first scanning target affixed to the rod such that the rod is aligned with a center point of the first scanning target, and (iii) a second scanning target affixed to the rod such that the rod is aligned with a center point of the second scanning target, the targeting device positioned such that the end point contacts the reference point;
determining, using the received scan data from the scanning of the targeting device, (i) 3D coordinates of the center point of the first scanning target and (ii) 3D coordinates of the center point of the second scanning target; and
calculating 3D coordinates of the end point based on (i) the 3D coordinates of the center point of the first scanning target, (ii) the 3D coordinates of the center point of the second scanning target, (iii) a distance between the center point of the first scanning target and the end point, and (iv) a distance between the center point of the second scanning target and the end point.

12. The method of claim 11, further comprising:
calculating a distance between the center point of the first scanning target and the end point based on (i) a distance between the center point of the second scanning target and the end point and (ii) a distance between the center point of the first scanning target and the center point of the second scanning target.

13. The method of claim 11, further comprising calculating a distance between the center point of the second scanning target and the end point based on (i) a distance between the center point of the first scanning target and the end point and (ii) a distance between the center point of the first scanning target and the center point of the second scanning target.

14. The method of claim 11, further comprising:
receiving scan data from a scan of a targeting device and a calibration target, the targeting device positioned such that the end point contacts a calibration point of the calibration target;
determining, using the received scan data from the scanning of the targeting device and the calibration target, (i) 3D coordinates of the center point of the first scanning target, (ii) 3D coordinates of the center point of the second scanning target, and (iii) 3D coordinates of the calibration point; and
calculating at least one of (1) the distance between the center point of the first scanning target and the end point and (2) the distance between the center point of the second scanning target and the end point based on (a) the 3D coordinates of the center point of the first scanning target from the scanning of the targeting device and the calibration target, (b) the 3D coordinates of the center point of the second scanning target from the scanning of the targeting device and the calibration target, and (c) the 3D coordinates of the calibration point from the scanning of the targeting device and the calibration target.

15. The method of claim 11, wherein the first scanning target comprises a first sphere and the second scanning target comprises a second sphere.
